(19) United States
(12) Patent Application Publication
(10) Pub. No.: US 2017/0316345 A1
(43) Pub. Date: Nov. 2, 2017

(54) MACHINE LEARNING AGGREGATION

(71) Applicant: KnuEdge Incorporated, San Diego, CA (US)

(72) Inventor: Douglas A. Palmer, San Diego, CA (US)

(21) Appl. No.: 15/498,201

(22) Filed: Apr. 26, 2017

Related U.S. Application Data
(60) Provisional application No. 62/328,491, filed on Apr. 27, 2016.

(51) Int. Cl. G06N 99/00; G06N 5/04; G06F 17/30

(52) U.S. Cl. CPC G06N 99/005; G06F 17/30864; G06N 5/043

(57) ABSTRACT

Methods, systems, and apparatus, including computer programs encoded on computer storage media, for implementing an intelligence aggregation system. One of the methods includes receiving, by an agent, one or more goal criteria. A search to identify one or more other agents in the system is performed. Connections with the one or more other agents are established, with each connection having an initial weight. Data outputs generated by each connected agent are received to iteratively update a model using the received data outputs and associated weights. If the current model generated from current weights for the connections of the one or more connected agents satisfies the one or more goal criteria, the output of the current model is published to a search engine.

### CROSS-REFERENCE TO RELATED APPLICATION

This application claims priority to U.S. Provisional Application No. 62/328,491, filed on Apr. 27, 2016. The disclosure of the prior application is considered part of and is incorporated by reference in the disclosure of this application.

### BACKGROUND

This specification relates to machine learning platforms.

Machine learning is a statistical technique for training a model to predict the value of a target variable given a set of input data. In other words, training a model means computing a function that takes the input features as arguments and returns a predicted value for the target variable as a result.

### SUMMARY

This specification describes a distributed computing system for aggregating and automating machine learning technologies. In this specification, such a system will be referred to as an intelligence aggregation system, or for brevity, an aggregation system.

The intelligence aggregation system aggregates machine learning technologies in the sense that it combines and connects multiple heterogeneous machine learning subsystems within a single distributed system. The system also aggregates the data that is consumed and produced by such heterogeneous subsystems and other subsystems. To do so, the system can transform this data into a common format.

The intelligence aggregation system automates machine learning technologies in the sense that it employs intelligent coordinating agents that automatically control the training and application of machine-learned models to accomplish particular goals. To solve goals that the agents are given, the agents search for other agents, establish connections with other agents, and train machine-learned models using the outputs generated by the agents with whom they have connected as features for the model.

Particular embodiments of the subject matter described in this specification can be implemented so as to realize one or more of the following advantages. An intelligence aggregation system allows users to harness the power of machine learning without requiring knowledge of programming or cloud computing. Many different heterogeneous algorithms and data streams can be aggregated into the same system. The combined data and algorithms reinforce each other to solve complex tasks. Data streams in the system include labeled data that is easy to understand. Agents in the system automatically solve problems by establishing connections with other agents in the system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a diagram of an example hardware architecture for an intelligence aggregation system.

FIG. 3 is a flow chart of an example process for generating an output satisfying one or more goal criteria.

FIG. 4A is a flow chart of an example process for searching for data sources by keywords.

FIG. 4B is a flow chart of an example process for searching for data sources by output curve.

FIG. 4C is a flow chart of an example process for searching for a sample of data sources.

FIG. 5 is a flow chart of an example process for generating a model from connected data sources.

Like reference numbers and designations in the various drawings indicate like elements.

### DETAILED DESCRIPTION

This specification describes a distributed computing system for aggregating and automating machine learning technologies. In this specification, such a system will be referred to as an intelligence aggregation system, or for brevity, an aggregation system.

The intelligence aggregation system aggregates machine learning technologies in the sense that it combines and connects multiple heterogeneous machine learning subsystems within a single distributed system. The system also aggregates the data that is consumed and produced by such heterogeneous subsystems and other subsystems. To do so, the system can transform this data into a common format.

The intelligence aggregation system automates machine learning technologies in the sense that it employs intelligent coordinating agents that automatically control the training and application of machine-learned models to accomplish particular goals. To solve goals that the agents are given, the agents search for other agents, establish connections with other agents, and train machine-learned models using the outputs generated by the agents with whom they have connected as features for the model.

In this specification, an agent refers to a software-implemented subsystem that can automatically interact with other agents in the aggregation system in order to generate output data that satisfies one or more goal criteria. In particular, upon each agent receiving one or more goal criteria, each agent can automatically search for, establish, and prune connections with other agents, receive outputs generated by the connected agents, generate one or more machine-learned models using the received outputs, process outputs received from one or more other agents with the trained models to generate one or more outputs, and provide the generated one or more outputs to be consumed by other agents in the system. Each agent may, but need not, have a 1-to-1 relationship with a virtual or physical underlying computing device. For example, an agent can be implemented by one or more coordinating computer programs installed on one or more computers in one or more locations.

Upon achieving a model that satisfies its goal criteria, each agent can continually process inputs according to the connections established with other agents and continually generate outputs by processing the inputs using the models that the agents have generated.

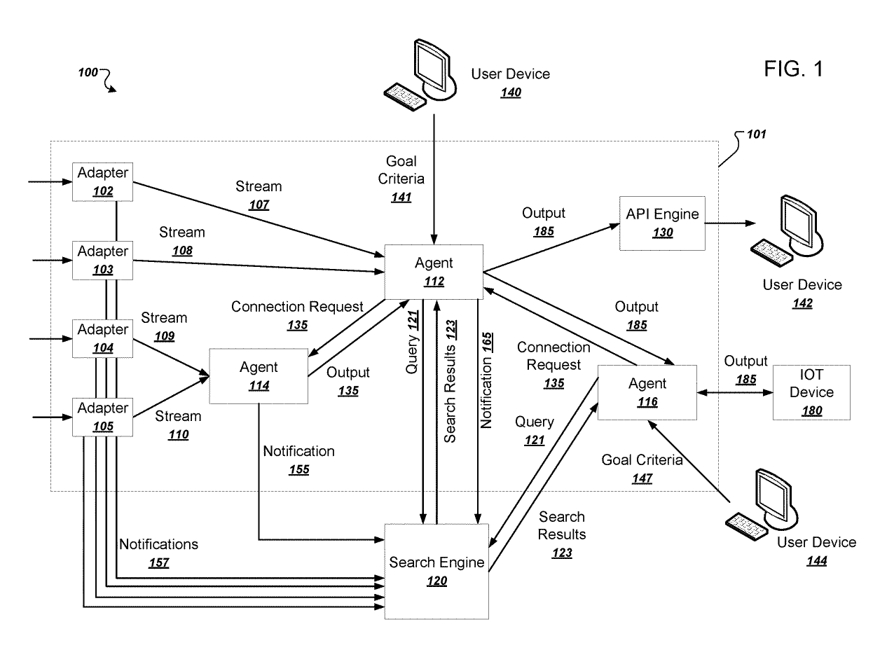

FIG. 1 is a diagram of an example system 100. The example system 100 includes an aggregation system 101 that is in communication with various other computing devices.

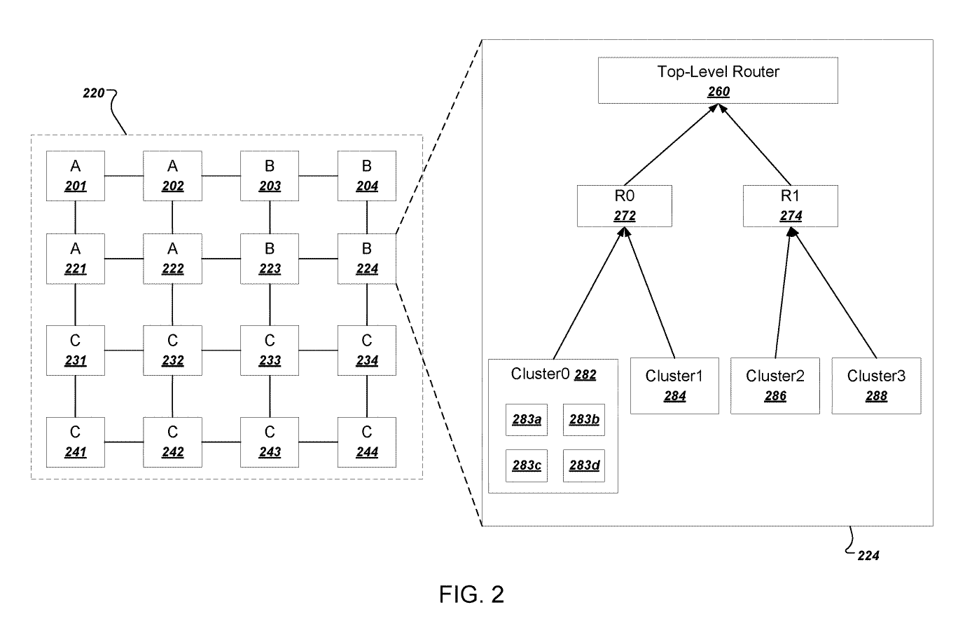

The example aggregation system 101 includes three agents 112, 114, and 116, a search engine 120, and an API engine 130. The aggregation system 101 also includes adapters 102, 103, 104, and 105. Each of these components can be implemented respectively as one or more computer programs installed on one or more computers in one or more locations. Each of these components can communicate with other components of the system over any appropriate combination of communications networks, e.g., an intranet or the Internet. In some implementations, one or more of these components are installed on a multiple-program, multiple-data co-processor system, which is described in more detail below with reference to FIG. 2.

Each of the adapters 102-105 is configured to continually ingest data from external sources outside the system 101 and to feed the ingested data as inputs to agents inside the system 101. For example, each of the adapters 102-105 can continually obtain information available on the Internet, e.g., stock prices, social media submissions, temperatures, news articles, and telemetry data, to name just a few examples.

The system 101 can maintain a set of external data sources from which respective adapters should generate corresponding data streams. In some implementations, the system 101 allocates one or more adapters for each of the external data sources in the maintained set of external data sources.

The adapters 102-105 can generate output data streams 107-110 that can be consumed by any of the other components of the system. In this specification, a stream of data outputs, or for brevity, “outputs,” refers to an unbounded sequence of data objects that are provided by one component of the system to another.

In order to support interoperability and scalability, all components of the system can generate data objects that are expressed in the common system format of the system. In some implementations, the components of the system generate data objects that are time-labeled tuples, each tuple having one or more elements.

Each element of each tuple represents one or more values of one or more respective attributes. The system can represent the data objects in the common system format using any appropriate structured data format. The system can maintain sets of attribute names and attribute types for all of the data objects that are exchanged in the system. For example, a tuple can include values for the following attributes of a particular location: wind speed, wind direction, temperature, and humidity. The tuple can also include a time stamp that represents when the values were recorded.

Each tuple can also include a cost value that represents a cost associated with consuming a data stream. For example, multiple different entities can establish and control different agents and adapters in the system. Each of the multiple different entities can determine a cost value associated with providing the output stream to agents controlled by other entities. More accurate and reliable data streams can be associated with higher costs, which can be encoded in the data streams themselves. Because of this, agents trying to build a model to satisfy one or more goal criteria can automatically determine whether or not to use certain streams based on a cost function associated with the goal criteria. If a certain high-quality stream is simply too costly for the goal criteria being processed by a particular agent, the particular agent can instead turn to lower cost data sources.

Each attribute type represents a class of attribute names. For example, the attribute name, e.g., “temperature on Jun. 14, 2003,” is an instance of the class “temperature,” which is an attribute type. In some implementations, the attribute types have associated units. For example, the attribute type “temperature” can have the associated unit “degrees Celsius.” The system can restrict comparisons to attributes having the same attribute type. The system can uniquely identify each attribute in the system by its assigned attribute name or by a unique, system-generated identifier. Each data object can also carry a time stamp that represents when the data object was output by the corresponding agent or adapter.

The elements in a data object can be explicitly labeled with their respective attribute names. Therefore, data objects belonging to any streams generated by adapters or other agents in the system can be inspected to understand their contents. This is unlike the inner connections of most machine learning algorithms, e.g., neural networks, in which the internal data representations generally do not have an understandable interpretation. For example, a system component can generate data objects with elements having the label “latitude” or “air speed,” along with values for the attribute corresponding to the label. In addition, the elements of the data objects can be labeled with appropriate units of measure, or the units of measure can be implicit from the data object itself. For example, a particular agent can output data objects that are implicitly treated as temperature values without be explicitly labeled as such.

In some implementations, the component receiving a data stream requests that the component that is providing the stream continue to do so indefinitely until receiving a request to stop the stream. For example, the adapter 102 can read temperature values for a particular location and can generate a data stream by continually or periodically providing data objects for consumption by other components in the system. In this example, each data object can have data elements representing latitude and longitude coordinates and a corresponding temperature reading.

When generating data streams 107-110, the adapters transform the ingested data into a common format of the system 101. For example, the adapters can receive ingested data and transform the data into a format that uses the attribute names and attribute types maintained by the system.

The adapters 102-105 can notify the system 101 of the availability of their output streams by providing notifications 157 to the search engine 120. This allows agents in the system to locate the adapters in order to connect to their output streams.

Each agent of the system can be configured to obtain, as input, one or more input streams and to generate an output. For example, the agent 114 takes as input data streams 109 and 110 and generates an output 135. The output 135 may but need not be a data stream itself. In other words, the output generated by an agent can be a bounded or unbounded sequence of data objects that are expressed in in the common format of the system described above.

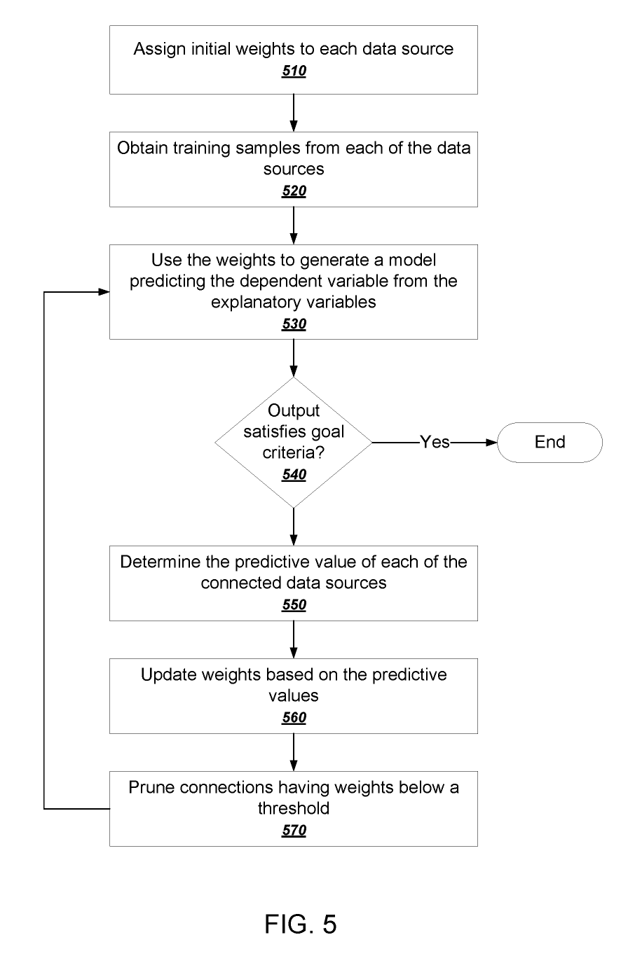

To generate an output, each agent can be configured to search for streams in order to train a model with which to process data from one or more input streams. As part of this process, some agents can establish other agents that do not search for streams on their own, but instead simply train a model with the streams they are given. Such agents that simply train a model with the streams they are given can be referred to as training agents. In some implementations, a user can control the process for searching for streams and establishing training agents. Training models is described in more detail below with reference to FIG. 5.

Upon generating an output, each agent can optionally feed the output back into the system 101. In other words, each agent can make each generated output available to be consumed by other agents in the system 101. In addition, the system 101 can archive the outputs that are generated by the agents in a system archive. In other words, the system can store each time-stamped tuple of output data, which can then be consumed by other agents for historical analysis later on.

To make their outputs available for consumption, each agent is configured to communicate with one or more search engines in the system, e.g., the search engine 120. For example, upon the agent 114 generating the output 135, the agent 114 can provide a notification 155 to the search engine 120. As mentioned above, adapters in the system 101 can also automatically provide corresponding notifications 157 to search engines in the system 101 in order to make their output data streams available for consumption by agents in the system 101.

The notifications 155 and 157 include information that is sufficient for other agents in the system to find the output 135. For example, the notification 155 can include one or more items of information, e.g., the attribute names of the output 135 and data representing the shape of output curves of the output 135 over time, to name just a few examples. Upon receiving the notifications 155 and 157, the search engine 120 updates an index that is appropriate for the particular output 135.

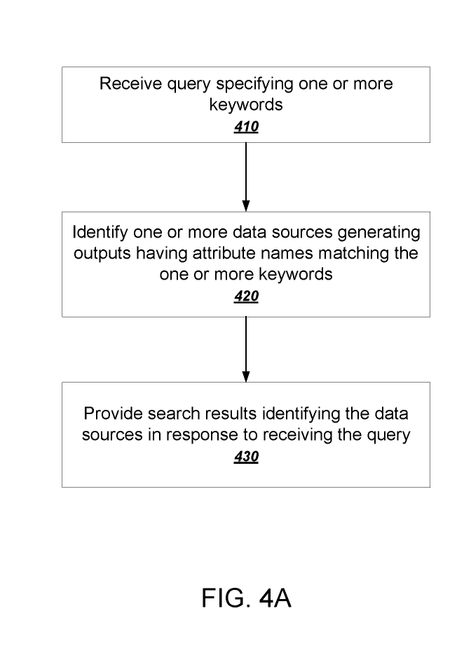

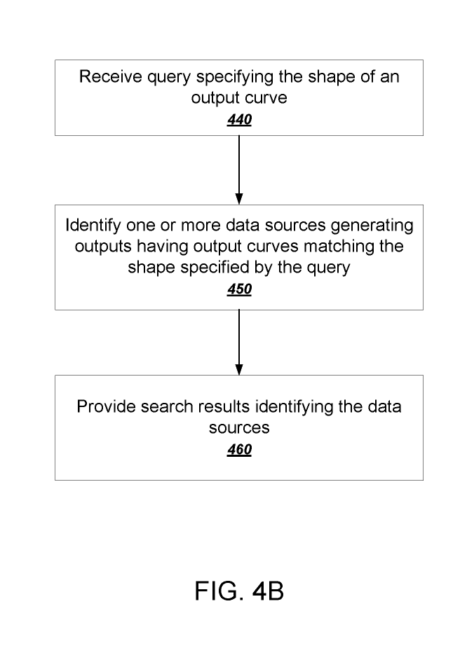

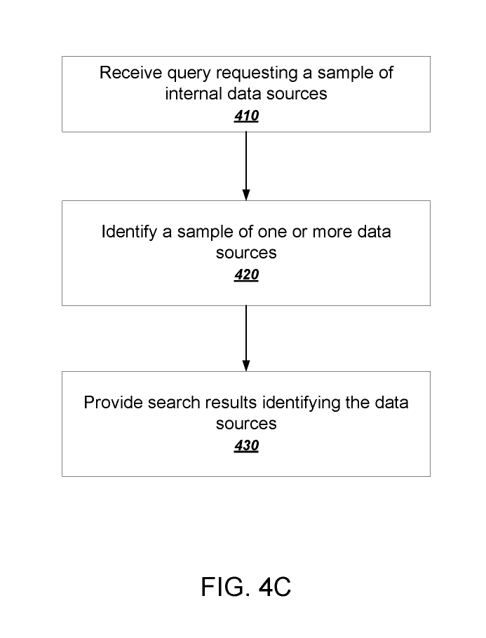

The search engine 120 receives queries that each identify one or more requested attributes of data generated by system components. The search engine 120 can respond to the queries with search results that each identify an appropriate system component within the system 101. Generally the search engine 120 can provide search results that identify any system a component that processes data and generates an output that can be consumed by other components within the aggregation system. For example, search engine can identify agents, adapters, or both. Searching for system components is described in more detail below with reference to FIGS. 4A-C.

The system 101 can have system-configured agents as well as user-configured agents. For example, the aforementioned agent 114 can be a system-configured agent that generates the output 135 from data streams 109-110 generated by adapters 104-105. The system can maintain a set of system-configured agents that generate some of the most commonly requested outputs. For example, the system 101 can have a system-configured agent that generates an output of common temperature statistics, e.g., an average temperature, from inputs of multiple system-maintained adapters.

User-configured agents, on the other hand, are agents that are given one or more goal criteria by users of the system. Each goal criteria represents a request to make a prediction using streams within the system. The goal criteria itself can specify one or more search criteria that agents should use to begin the training process. The goal criteria can specify one or more tags that represent attribute names of output streams that an agent should search for. For example, the goal criteria 141 can represent that an agent should build a model to predict the price of a particular commodity by providing tags representing streams having attribute names “temperature” and “precipitation.”

The goal criteria can also specify a particular error value that represents a maximum acceptable error level. Because no model is perfect, each model generated by an agent will attempt to minimize errors, but will still generate some errors.

The goal criteria can also specify a maximum cost for a cost function that the agent cannot exceed when building the model. Therefore, the agent will automatically reject candidate models that cannot be trained under the maximum cost specified by the goal criteria.

The user-configured agents then interact and coordinate with other agents to generate outputs that satisfy the goal criteria. For example, the agents 112 and 116 are user-configured agents because they receive user-specified goal criteria. Although only two user-configured agents are shown, a typical aggregation system will have many more user-configured agents that are active, e.g., up to 10,000, 100,000, or 1 million user-configured agents. All of these user-configured agents generate outputs for consumption by other agents in the system.

For example, the agent 112 is a user-configured agent. The agent 112 receives one or more goal criteria 141 from the user device 140. The user device 140 can be any appropriate computing device that is capable of communicating with the system 101 over a network. For example, the user device 140 can be a personal computer and a user having an account with the system 101 can log on to the system 101 and provide the agent 112 with the goal criteria 141.

Upon receiving the goal criteria 141, the agent 112 automatically performs a process to seek out data sources in the system 101 for satisfying the goal criteria. For example, upon receiving the goal criteria 141, the agent 112 can provide a query 121 to the search engine 120. The query 121 is a query that seeks to find other agents that produce outputs related to the goal criteria 141. The search engine 120 responds to the query 121 with search results 123 that each identify component in the system 101. In this example, the agent 112 uses the search results 123 to begin consuming data streams 107-108 generated by the adapters 102-103.

The agent 112 also uses the search results 123 to provide a connection request 135 to the agent 114. Unlike adapters, agents in the system 101 are not required to provide their outputs to any other agent that requests it. Rather, a first agent provides a connection request to a second agent, and the second agent may grant or deny the connection request. The decision to grant or deny the connection request can be based on a user configuration of the agent or resource limits of the agent being reached. If the agent 114 grants the connection request 135, the agent 114 will begin providing its output 135 to the agent 112 that requested the connection.

Upon establishing connections with one or more system components, the agent 112 begins training one or more models in order to satisfy the user-provided goal criteria 141. Upon generating an output 185 that satisfies the goal criteria 141, the agent 112 provides a notification 165 to the search engine 120 so that other agents in the system can consume the output 185.

The agent 112 can provide the output 185 to an API engine 130, which makes the output 185 available for consumption by external consumers. For example, a user of user device 142 can access the output 185 by communicating with the API engine 130. Each API engine in the system 101 receives outputs generated by agents, adapters, or both, and generates a presentation that is suitable for consumption by external consumers. For example, if the output 185 is a predicted stock price distribution, the API engine 130 can generate a graphical presentation that represents the predicted stock price distribution. The API engine 130 can then provide the graphical presentation to the user device 142 for presentation to a user.

Because the aggregation system 101 aggregates the outputs generated by the multitude of agents in the system, agents need not always generate new outputs when given certain goal criteria. In other words, instead of using a search engine to find inputs suitable for computing a model and generating a new output, an agent might use the search engine to find other agents in the system that have already solved the same or a similar problem.

For example, upon receiving the goal criteria 147 from the user device 144, the agent 116 can search for other agents in the system that have already solved the same or similar goal criteria. To do so, the agent 116 provides a query 121 to the search engine 120. The search engine provides search results 123 that indicate that the agent 112 has already achieved the same or similar goal criteria.

Thus, rather than generating a new output stream, the agent 116 simply provides a connection request 135 to the agent 112. If accepted, the agent 116 begins receiving the output 185 generated by the agent 112.

The aggregation of intelligence by the system 101 allows users of the system to configure relatively low-tech devices to perform highly sophisticated operations. In other words, the intelligence aggregation system 101 allows complex decision making to be performed by coordinating agents within the system 101 rather than by external devices themselves. The outputs can then simply be fed into the external devices without those devices being required to perform complex machine learning or data ingestion operations.

In particular, so-called “Internet of Things” (IOT) devices can leverage the aggregation system 101 to perform complex tasks. An IOT device is an Internet-enabled device having software and electronics configured to (1) receive input data from one or more sensors and to communicate such received input data over a network, (2) receive, over the network, one or more commands that are executed by actuators of the device, or both. Common actuators include lights, displays, or physically moving parts. Some devices may be both sensors and actuators. For example, a camera can receive a command to take a picture and, in response, obtain a digital image in a digital representation. In addition, some sensors and actuators may be integrated on a same physical device. Such devices can communicate information on any appropriate network, which need not be the Internet.

For example, the IOT device 180 uses the aggregation system 101 by communicating with the agent 116. The agent 116 provides its output 185 to the IOT device 180, which can take an appropriate action. For example, the IOT device 180 may be a physical water pump located in farming country. A user of the user device 144 can specify the goal criteria 147 to be maximizing the irrigation efficiency of the water pump based on predicted temperature, humidity, soil conditions, and recent rainfall data. In this example, the output 185 provided to the IOT device 180 can be a start time and a duration for the water pump to turn on. This output 185 is thus a solution to the goal criteria 147 specified by the user of the user device 144. Thus, instead of the water pump having to perform complex machine learning and prediction operations, those tasks are pushed inside the aggregation system 101. The water pump can thus have a relatively low-tech IOT device functionality.

In some implementations, external IOT devices 180 can be configured to provide their own goal criteria to agents within the aggregation system 101. For example, an IOT device 180 can be programmed with particular goal criteria and with the capability to provide goal criteria to agents within the system 101.

External IOT devices can also be sources of data input. In this case, the system 101 can allocate one or more adapters to handle ingestion of data generated by external IOT devices.

FIG. 2 is a diagram of an example hardware architecture for an intelligence aggregation system. The components of an intelligence aggregation system can be implemented on any appropriate underlying computing architecture, e.g., x86 processors. However, the performance of an intelligence aggregation system can be improved when the components of the system execute on multiple program, multiple data (MPMD) co-processor chips. This is because the large volumes of heterogeneous data that is transferred within an intelligence aggregation system makes efficient handling of scatter/gather operations very important. In particular, an intelligence aggregation system performs more effectively in systems that provide low-latency, multi-dimensional interconnects between machines, efficient routing, and small packets of information. Examples of suitable MPMD co-processor chips are described in commonly owned U.S. patent application Ser. Nos. 14/608,489, 14/608,505, 14/608,515, 14/608,693, and 14/608,670, all of which were filed on Jan. 29, 2015, and all of which are incorporated here by reference.

FIG. 2 illustrates connections for a single complex 220 of MPMD co-processor chips. Each of the chips has a direct wired connection to one or more other chips in the complex 220. For example, chip 201 has a direct wired connection to the chips 202 and 221. Typically, the chips of a complex are co-located in a same computing device, e.g., on a same rack in a datacenter.

The chips in a complex can simultaneously and securely execute multiple different programs concurrently from multiple application domains. For example, chips 201, 202, 221, and 222 each execute programs in a first application domain, “A.” Chips 203, 204, 223, and 224 each execute programs in a second application domain, “B,” and chips 231-234 and 241-244 each execute programs in a third application domain, “C.” Each of the application domains can correspond to a single agent or adapter of an intelligence aggregation system. The architecture of the complex ensures that data and instructions of programs executing in a particular application domain are insulated from snooping or contamination by programs executing in a different application domain.

Each chip in the complex has multiple clusters, and each cluster in a chip has multiple computing cores. For example, the chip 224 has clusters 282, 284, 286, and 288. The cluster 282 has four processing cores 283a-b. However, each chip can have any appropriate number of clusters., e.g., 2, 4, 8, 16, 32, or 64, and each cluster can have any appropriate number of processing cores, e.g., 2, 4, 8, 16, 32, or 64. Generally the computing cores on a single chip are able to access the same data in the same address space. Thus, in order to coordinate on a particular computing task, the processing cores need not use traditional network communications at all. Rather, the relevant data is co-located on the same chip for the processing cores to access and manipulate as necessary.

The processing cores in an MPMD co-processor can operate by exchanging small data packets, which may be referred to as flit packets. Each flit packet encodes an operation to be performed by a particular processing core in the complex. Thus, flit packets can be routed to any chip, cluster, and processing core within the complex without resorting to traditional network communications for transferring data.

The chip 224 has a top-level router 260 that routes traffic to and receives traffic from other chips with which the chip 224 has a direct wired connection. The chip 224 also has two intermediate routers 272 and 274 that route flit packets from the top-level router 260 to the clusters and then to the individual processing cores.

Processing cores within a cluster, and clusters within a chip, generally share the same high-speed memory devices and can read from and write to the same address spaces. Thus, the aggregation system can take advantage of co-located data in order to efficiently handle data communications in the system.

A complex, e.g., the complex 220, can host multiple applications. But generally, each chip is dedicated to a single application. In the example shown in FIG. 2, the chips 201, 202, 221, and 222 execute application A. The chips 203, 204, 223, and 224 execute application B. And the chips 231-234 and 241-244 execute application C. In an intelligence aggregation system, application A might be an adapter, application B might be an agent, and application C might be a search engine of the system. All of these heterogeneous components with their heterogeneous inputs and outputs can co-exist within a single complex.

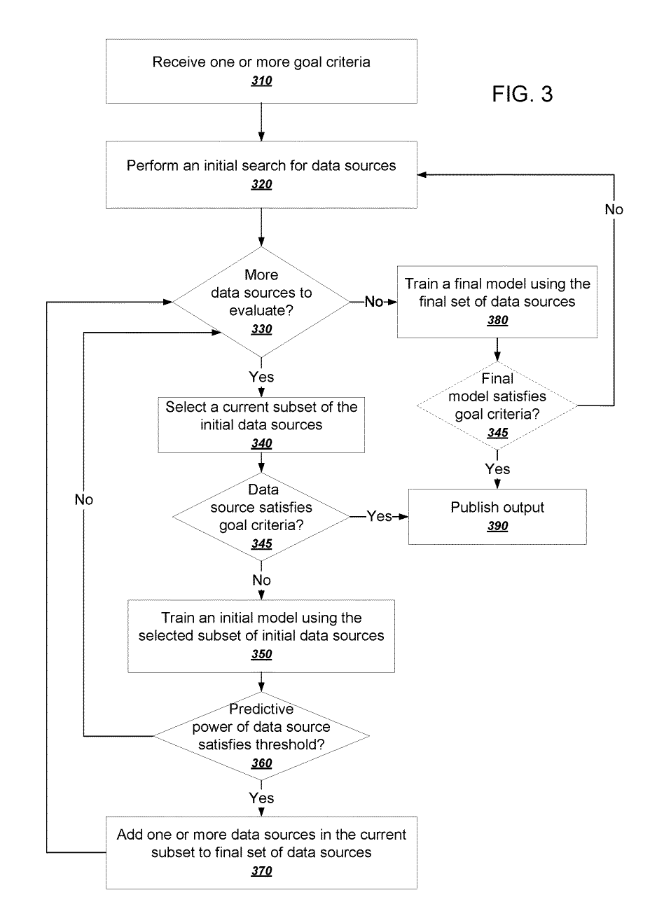

FIG. 3 is a flow chart of an example process for generating an output satisfying one or more goal criteria. The example process will be described as being performed by an appropriately programmed agent of an intelligence aggregation system, e.g., the intelligence aggregation system 101 of FIG. 1.

The agent receives one or more goal criteria (310). As described above, the goal criteria can be provided to the agent by the system or by a user.

Generally, the goal criteria specify at least one desired output to be predicted by the agent. The agent can coordinate with other agents to train or obtain a model that predicts the desired output, in which case the desired output is the target variable of the model. The agent can also obtain predictions for the desired output from another agent. The goal criteria has one or more parts, each of which can be specified by corresponding part identifiers. As an example, assume that a user wants to predict tomorrow's temperature. To do so, the user can provide the agent with data that specifies the attribute name “tomorrow's temperature” for the goal, which may have any appropriate part name, e.g., “goal,” “target variable,” or “desired output.”

In some implementations, the system uses reserved keywords that associate attribute names with parts of the goal criteria. For example, the system can use an appropriate reserved keyword, e.g., “predict,” so that users can specify goal criteria with natural language phrases, e.g., “predict tomorrow's temperature.” In this example, the system can parse the goal criteria to recognize the predict keyword and the attribute name “tomorrow's temperature.”

The system can also use a knowledge base to make specifying the goal criteria with natural language phrases more robust. For example, the system can maintain or use a knowledge base that associates real-world entities with their corresponding names. The system can then use the knowledge base to disambiguate attribute names or part names that are received in user-specified goal criteria.

Alternatively or in addition to using attribute names, the goal criteria can specify the desired output according to the shape of an output curve. For example, the goal criteria can specify a feature vector that represents the desired shape of an output curve. The agent can then seek to find agents that produce the most similar output to the output curve, or the agent can seek to train a model that most closely resembles the output curve.

The goal criteria may also specify required or optional input parameters. The input parameters identify features that the agent is required to use or suggested to use, if available, when training a model. A user may find it useful to specify input parameters in situations where there is a known strong correlation between features available in the system and the desired target variable.

The input parameters that are designated as required forces the agent to use required input parameters if they are available. If a required input parameter specified by the goal criteria is not found, the agent can generate an error notification. In contrast, if an optional input parameter is not available, the agent may still generate an output rather than returning an error notification.

If the user is specifying the goal criteria with natural language phrases, a user can specify the input parameters with an appropriate keyword, e.g., “based on,” or “using,” followed by the corresponding attribute names. For example, the user can specify input parameters for predicting tomorrow's temperature using today's rainfall with a phrase “based on today's rainfall.” The system will then treat the attribute name “today's rainfall” as a required or optional input parameter.

The goal criteria can also specify value ranges for the input parameters in order to constrain the feature values that the agent will use when training the model. For example, if the agent is predicting weather patterns, a user can provide value ranges in order to constrain the feature values that the agent uses to events that occurred within the previous day, week, or month.

The goal criteria can also specify a performance metric and a quality threshold. The performance metric specifies how the output generated by the agent should be measured. For example, the output generated by the agent can be measured by a number of correct predictions during a particular time period, an average error value between predictions made by the model and a control set, or any other appropriate metric for measuring the quality of a predictive model. If the goal criteria specified a desired output curve, the performance metric can be explicitly or implicitly a measure of curve similarity.

The quality threshold specifies a value of the performance metric that, if achieved, indicates that the goal criteria have been satisfied. In other words, if the performance metric for the model meets or exceeds the quality threshold, the agent can consider the model to have been sufficiently trained according to the goal criteria.

Both the performance metric and the quality threshold can be specified with natural language phrases as well. For example, a user can specify a quality threshold of “95%” and a performance metric “accuracy” by specifying the phrase “with 95% accuracy.”

The agent performs a search for data sources (320). The agent can first narrow down the many thousands or millions of possible data sources that are available in the system by performing a search. As the process proceeds, the agent can perform additional steps to narrow down the data sources that are used to build a final model.

The agent can use one or more search engines to search for data sources in a variety of ways. As described above, system components that can be used as data sources include agents and adapters. Adapters are system-configured components of the system that ingest and convert external information and provide it to consumers inside the system.

In order to search for data sources, the agent can provide keywords associated with the different attribute names in the goal criteria to a search engine. Different methods for searching for initial data sources are described in more detail below with reference to FIGS. 4A-C.

In order to train a model that generates an output specified by the goal criteria, generally the agent has find at least one data source, e.g., an agent or an adapter, that produces an output having the same attribute type as the output specified by the goal criteria. This output will be used as the target variable of the model.

For example, if the goal criteria specify that the agent should predict tomorrow's temperature, the agent will search for at least one other data source that generates outputs having the “temperature” attribute type. Thus, the agent will typically search for at least one data source that generates an output having the attribute type specified by the goal criteria. If the agent is directed to predict a target variable that is a real-world attribute name, e.g., “temperature,” the agent may select an adapter as the data source, rather than another agent, because adapters ingest external data, including real-world attribute names that can be used as target variables of a model.

The agent will also search for data sources having outputs that serve as features of the model. If the goal criteria specified one or more input parameters, the agent can search for data sources that generate outputs having attribute types matching the attribute types of the input parameters. For example, if the input parameter is an attribute name “rainfall yesterday,” the agent will search for other data sources that generate outputs having the same attribute type as “rainfall yesterday.”

The agent can then establish connections with the data sources. Generally, an agent will connect with at least one data source that generates the target variable to be predicted, and one or more other data sources that generate features for predicting the target variable.

As described above, generally any agent can connect to any adapter that the system provides. But in order to connect to other agents, an agent typically provides a request to connect to the other agent. Upon the request being granted, the agent starts receiving outputs generated by the connected agent.

If any of the other agents denied the request to connect, the process can optionally return to step 320 for the agent to search for more data sources.

The agent determines whether there are more data sources to evaluate (330). Before training a final model, the agent can evaluate each of the initial data sources identified by the initial search. To do so, the agent can evaluate smaller subsets that each contain one or more of the initial data sources.

The agent selects a next subset of the initial data sources (340). The agent can evaluate each of the initial data sources in small batches in order to determine which data sources to keep for the final model. This process further filters down the number of data sources that are used to build the final model by discarding data sources that are not predictive enough for the stated goal. Although some machine learning algorithms may be able to reduce the influence of insufficiently predictive data sources during training, it is generally orders of magnitude faster to eliminate the data sources in the first place by training many small, initial models. In this context, a model being smaller means that it has fewer inputs, less training data, and is trained in less time than the final model. When the initial models and the final model are neural networks, being smaller can also mean that the initial models have fewer neural network layers than the final model.

In general, the time to train a model grows approximately quadratically with the number of inputs to the model. For example, if a model has 40 potential inputs to consider, training a single model using all 40 inputs simultaneously might take 1600 units of time. But equivalent training on models using only 10 inputs at a time might be conducted in only 100 units of time. This requires training 4 models, using a total of 400 units of time instead of 1600.

If the number of potential inputs is larger, e.g., 10,000 potential inputs, the savings grows significantly larger as well, e.g., 10,000 units of time vs. 100,000,000 units of time.

Some accuracy may be lost using this technique. In particular, one input may help prediction significantly only when combined with some other input. When performing piece-wise training, the system risks losing some inputs that could have improved the model, because others input needed for to make the input significant weren't present in the same training set.

This disadvantage is quite small compared to the advantages. Training time is the primary constraint on model building, and it is rarely possible to evaluate all possible inputs. The segmented training procedure allows sampling more potential inputs in a reasonable time frame could be evaluated using more traditional training procedures.

The agent determines whether any data sources in the current subset of data sources satisfies the goal criteria (345). In other words, the agent can evaluate the predictive quality of the data sources in the current subset and compares the predictive quality to the goal criteria. To do so, the agent compares the output of each data source to be used as input parameters with the output of the data source generating the target variable. The agent can then compute, for the output of each of the data sources being used as input parameters, whether the performance metric specified by the goal criteria satisfies the quality threshold of the goal criteria. If so, that means that another agent or adapter is already generating an output that sufficiently predicts the target variable.

Thus, instead of building a new model, the agent simply selects the data source and publishes that output (branch to 390) and the process ends.

As described above, to publish its output, the agent provides the attribute name of its output to a search engine. This indicates to the search engine that the agent is now generating an output having the attribute name, and thus other agents can consume the output generated by the agent.

If none of the outputs of the data sources in the current subset satisfy the goal criteria, the agent trains a model using the outputs of the data sources in the current subset (branch to 350). Training a model means that the agent computes a function that takes as input feature values computed from the data sources, and from those feature values the function assigns a predicted value to the target variable. The agent can use training samples obtained from the outputs of the connected data sources in order to compute the function.

During the training process, the agent iteratively adjusts respective weights for connections to each of the connected data sources. To do so, the agent assigns an initial weight to each of the connected data sources. The agent then iteratively trains a model using the weights of the connections as weights for the corresponding features. The agent computes new weights for the connections based on how well the corresponding features affect the performance of the model. The agent then updates the model by retraining the model with the new weights. The process of training a model and adjusting the weights of the connections is described in more detail below with reference to FIG. 5. Because the agent uses only data sources in the currently selected subset of data sources, training the initial model is typically much faster than training the final model.

The agent determines whether the predictive power of a data source in the current subset satisfies a threshold (360). In other words, the agent determines whether or not any of the data sources used to train the initial model are predictive enough to be used for the final model.

In some implementations, the agent determines a prediction score for the initial model that represents how well the initial model trained on the subset of data sources predicts the target variable. If the prediction score satisfies the threshold, the agent can designate the data sources used to train the initial model as having sufficient predictive power.

As another example, the training processes of some machine learning algorithms assign weights to the various input data sources. If using such an approach, the agent can select data sources that were assigned, by the training process, non-zero weights or weights that satisfy a threshold.

The system can dynamically adjust the threshold based on the input data sources in a variety of ways. For example, the system can compute a mean and standard deviation of the weights and use a particular number of standard deviations as the threshold. For example, the system can discard weights that are more than some number of standard deviations below the mean, e.g., 2 or 3 standard deviations. As another example, the system can define a fixed number of inputs, keep the fixed number of input streams that have the most significant weights, and discard the remaining input streams. If none of the data sources in the current subset had sufficient predictive power, the agent can again determine if there are more data sources to evaluate (branch to 330).

On the other hand, if at least one of the data sources in the current subset had sufficient predictive power, the agent can add one or more of the data sources in the current subset to a final set of data sources (branch to 370). The agent can effectively discard the other data sources by disconnecting from those data sources.

If there are no more data sources to evaluate (330), the agent trains a final model using the final set of data sources (branch to 380). Typically, the final set of data sources is much larger than each of the subsets used to select the data sources in the final set. Therefore, training the final model typically takes much longer than training any of the initial models.

After training the final model using the final set of data sources, the agent can publish its output (390). The agent can then begin making predictions using the connected data sources and their associated weights. Generally, the agent will ingest much more data to train the model than is required for making a prediction. For example, the agent might ingest ten years' worth of data to generate a model that predicts temperature. But the actual prediction using the model might require only a single day's worth of data.

In addition, once the model is trained the agent can share the model with other agents. The other agents then also use the model to begin making predictions without having to perform the iterative training process.

To do so, the agents that borrow the model, referred to as the borrowing agents, can receive the model parameters from the agent that trained the model. The borrowing agents can then establish connections to the same or similar data sources that the training agent used to train the model.

In some implementations, the agent can publish its output only if the output satisfies the goal criteria. On the other hand, if the output of the final model generated by the agent does not satisfy the goal criteria, the agent can iteratively update the final model until the goal criteria is satisfied or until a maximum number of iterations is reached.

For example, the agent can determine how well its outputs predict the data objects generated by a data source that generates data objects corresponding to the target variable. The agent can collect training data from the connected data sources and train a model using the training data. The agent can then use the model to begin making predictions, based on the features of the model, of the target variable being output by the data source. In some cases, a time lag exists between the time of the prediction and the time that the prediction is checked for accuracy. For example, if the model predicts temperatures 7 days from now, the actual temperatures in 7 days are required in order to gauge the performance of the model.

If the output does not satisfy the goal criteria, the agent can update the model by performing a new search for data sources (branch to 320). In other words, the agent tries a new combination of data sources. The agent can use a different search technique to find the new combination of data sources, or the agent can simply find additional sources that were not evaluated before. The agent can thus continually make new connections until the output satisfies the goal criteria.

In some implementations, if the final model's output does not satisfy the goal criteria, the system optionally determines whether a maximum number of iterations has been reached. If so, the process returns to step 320 and the agent searches for new data sources for trying to achieve the goal criteria. If not, the process ends.

FIG. 4A is a flow chart of an example process for searching for data sources by keywords. The process can be performed by a search engine in an intelligence aggregation system. The process will be described as being performed by an appropriately programmed system of one or more computers.

The system receives a query specifying one or more keywords (410). As described above, an agent can provide a query that specifies, as keywords, one or more attribute names. The attribute names can correspond to attribute names of an output specified by the goal criteria as well as attribute names of input parameters of the goal criteria.

The system identifies one or more data sources generating outputs having attribute names matching the one or more keywords (420). The system can, for example, maintain a set of posting lists for each attribute name and attribute type maintained by the system. For each attribute name, the corresponding posting list has identifiers for system components, e.g., agents or adapters, that generate outputs having that attribute name. For each attribute type, the corresponding posting list has identifiers for system components, e.g., agents and adapters, that generate outputs having the attribute type.

In order to be a match to a keyword, an output generated by system component has to at least match the attribute type of the keyword. In some implementations, the system ranks matches to attribute names higher than matches to attribute types. For example, if the query specifies “rainfall yesterday” as the attribute name, the attribute name “rainfall last month” matches the attribute type “rainfall” but not the attribute name. Thus, the system can rank a first data source having a matching attribute name higher than a second data source having only a matching attribute type.

The system provides search results identifying the data sources in response to receiving the query (430). For example, the system can provide the internal network addresses of the system components that are identified as data sources.

FIG. 4B is a flow chart of an example process for searching for data sources by output curve. The process can be performed by a search engine in an intelligence aggregation system. The process will be described as being performed by an appropriately programmed system of one or more computers.

The system receives a query specifying the shape of an output curve (440). As described above, an agent can provide a query that specifies the shape of a desired output curve. For example, the query can specify a vector of values, wherein each value represents an output value at a particular point in time.

The system identifies one or more data sources generating outputs having output curves matching the shape specified by the query (450). In other words, the system determines which system components generate output data having output curves with shapes that most closely match the curve specified by the query. An output curve can be considered a match when an appropriate measure of similarity between the curves satisfies a threshold.

The system can use any appropriate statistical technique for computing the similarity between curves, e.g., dynamic time warping, Procrustes analysis, or the Frechet distance, to name just a few examples. The system can then rank the data sources according to the computed measures of similar between the output curves.

The system provides search results identifying the data sources in response to receiving the query (460). For example, the system can provide the internal network addresses of the system components that are identified as data sources

FIG. 4C is a flow chart of an example process for searching for a sample of data sources. The process can be performed by a search engine in an intelligence aggregation system. The process will be described as being performed by an appropriately programmed system of one or more computers.

The system receives a query requesting a sample of data sources (440). In contrast to keyword or shape-based matching, the system can also provide a random sample of data sources to an agent searching for connections. This type of searching can be beneficial when a user wants an agent to discover new correlations in data.

Although the data generated by a randomly selected agent may not be expected to be beneficial, in the aggregate it is statistically probable that the agent will find some agents that generate useful outputs. Which agents generate beneficial outputs will be sorted out during training of the model, which is described in more detail below.

The system can randomly or pseudorandomly generate a sample of data sources. The system can also select as data sources system components that are physically located close to the requesting agent.

In some implementations, the system generates a sample that has a particular distribution of agents to adapters. For example, the system can generate a sample that is 50% agents and 50% adapters or 90% agents and 10% adapters.

The system provides search results identifying the data sources in response to receiving the query (460). For example, the system can provide the internal network addresses of the system components that are identified as data sources.

FIG. 5 is a flow chart of an example process for generating a model from connected data sources. In other words, the example process assumes that the agent has already established connections with one or more data sources. The example process will be described as being performed by an appropriately programmed agent of an intelligence aggregation system, e.g., the intelligence aggregation system 101 of FIG. 1.

The agent assigns initial weights to the connection with each data source (510). For example, the system can have a default initial weight, e.g., 0.5 or 1.0, that is assigned to each connection upon being established initially.

The agent obtains training samples from the data sources (520). Generally, one output of the data sources is considered the target variable during training, and the rest of the outputs are considered features. Thus, each training sample associates a value of the target variable with one or more feature values from outputs generated by the data sources. Each training sample thus includes, for both the features and target variable, values for the corresponding attribute names. For example, the agent can generate training samples by obtaining, for each of multiple time periods, attribute values for the features and the target variable.

The agent uses the weights to generate a model predicting the target variable from the features (530). The agent can use any appropriate machine learning technique that uses and adjusts weights of features to build a model, e.g., back propagation or other neural network techniques. For example, the system can use the features with an initial model to generate a predicted value for the target variable. The actual value of the target variable can then be used to update the weights of the connections, e.g., by using back propagation.

After training, the agent can use the model to generate, for a new set of attribute values in the outputs generated by the connected data sources, a predicted value for the target variable.

The agent determines whether the output satisfies the goal criteria (540). The system can use any appropriate technique for measuring the performance of the model, e.g., cross validation. As described above, the technique or performance metric may be specified by the goal criteria.

For example, if the goal criteria specifies that cross validation should be used to evaluate the performance of the model, the system can obtain validation samples in a similar way to obtaining the training samples, or the system can hold out the validation samples from the training samples. The agent can then compare the prediction of the model on the validation samples with the actual values of the target variable in the validation samples. The agent can repeat the process for various combinations of held out data and then compute an overall performance metric from the results. The agent can then determine whether the overall performance metric satisfies the quality threshold specified by the goal criteria.

If the output of the model satisfies the goal criteria, the process ends (branch to end). As described above with reference to FIG. 3, the agent can then publish these results so that other consumers in the aggregation system can use them.

If not, the agent will update the weights and retrain the model. To do so, the system determines the predictive value of each of the connected data sources (550). In other words, the system computes a measure of how well the output generated by each data source predicted the values of the dependent variables.

The agent then updates the weights based on the predictive values of the data sources (560). Data sources that had weaker predictive power have their weights reduced, while data sources that had stronger predictive power have their weights increased.

The agent prunes connections having weights below a threshold (570). In other words, the agent terminates the connection with any data source whose weight has fallen below a particular threshold. The agent then again uses the weights to generate a model predicting the dependent variable from the explanatory variables (530). In this way, the agent zeroes in on which of the data sources are most valuable for predicting the output specified by the goal criteria.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) monitor, an LCD (liquid crystal display) monitor, or an OLED display, for displaying information to the user, as well as input devices for providing input to the computer, e.g., a keyboard, a mouse, or a presence sensitive display or other surface. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
one or more computers and one or more storage devices storing instructions that are operable, when executed by the one or more computers, to cause the one or more computers to implement a plurality of agents, each agent being configured to perform operations comprising:
receiving one or more goal criteria;
performing a search to identify one or more other agents in the system that generate data outputs that are candidate features for training a model satisfying the goal criteria;
establishing a respective connection with the one or more other agents, each connection having an initial weight;
receiving data outputs generated by each connected agent;
iteratively training a model using the received data outputs from each connected agent as features and adjusting the respective weights of the connections for each connected agent;
determining that a current model generated from current weights for the connections of the one or more connected agents satisfies the one or more goal criteria; and
publishing output of the current model to a search engine.

2. The system of claim 1, wherein the operations further comprise:
evaluating each subset of a plurality of subsets of the data outputs generated by the connected agents, including:
generating an initial model using only data sources in the subset,
determining, for each data source in the subset, whether the data source is sufficiently predictive of a target variable of the goal criteria, and
adding, to a final set of data sources, only the data sources in the subset that are sufficiently predictive of the target variable of the goal criteria; and
training the model using only data sources in the final set of data sources.

3. The system of claim 2, wherein each initial model has fewer inputs, less training data, and requires less training time, than the final model.

4. The system of claim 1, wherein the operations further comprise:
receiving, from another agent, a request to establish a connection; and
providing the output of the current model to the other agent for consumption by the other agent in response to the request.

5. The system of claim 1, wherein the one or more storage devices further store instructions that are operable, when executed by the one or more computers, to cause the one or more computers to implement a search engine configured to perform operations comprising:
receiving, from a first agent, a publication of output data generated by the first agent;
receiving, from a second agent, a query for output data;
determining that the output data generated by the first agent satisfies the query; and
providing an identification of the first agent to the second agent.

6. The system of claim 5, wherein the query specifies one or more keywords, and wherein determining that the output data generated by the first agent satisfies the query comprises determining that the output data has an attribute name matching the keywords in the query.

7. The system of claim 5, wherein the query specifies a shape of an output curve, and wherein determining that the output data generated by the first agent satisfies the query comprises determining that the output data matches the shape of the output curve specified in the query.

8. The system of claim 5, wherein the one or more computers implementing the search engine perform operations comprising obtaining a random or pseudorandom sample of agents in the system.

9. The system of claim 1, wherein the operations further comprise:
after adjusting the respective weights of the connections for each connected agent, determining that a particular weight of a particular connection satisfies a threshold; and
in response to determining that a particular weight of a particular connection satisfies a threshold, terminating the connection.

10. The system of claim 1, wherein the goal criteria specifies an attribute name of a desired output, and wherein the operations further comprise performing a search to identify one or more other agents that generate data outputs matching the attribute name of the desired output.

11. The system of claim 1, wherein the goal criteria include one or more input parameters, wherein each input parameter specifies an attribute name of a feature to use to train the model.

12. The system of claim 11, wherein performing a search to identify one or more other agents in the system that generate data outputs that are candidate features for training a model satisfying the goal criteria comprises performing a search to identify one or more other agents that generate outputs matching at least one attribute name in the one or more input parameters.

13. The system of claim 1, wherein the goal criteria include a performance metric and a quality threshold, wherein the operations further comprise computing the performance metric after each model is trained, and wherein determining that the current model satisfies the one or more goal criteria comprises determining that the computed performance metric satisfies the quality threshold.

14. The system of claim 1, wherein the operations further comprise performing a search to identify one or more system-configured adapters that are configured to ingest data from outside the system and to generate outputs corresponding to the ingested data.

15. A computer-implemented method for implementing a plurality of agents in an intelligence aggregation system, the method comprising:
receiving, by an agent, one or more goal criteria;
performing, by the agent, a search to identify one or more other agents in the intelligence aggregation system that generate data outputs that are candidate features for training a model satisfying the goal criteria;
establishing, by the agent, a respective connection with the one or more other agents, each connection having an initial weight;
receiving, by the agent, data outputs generated by each connected agent;
iteratively training, by the agent, a model using the received data outputs from each connected agent as features and adjusting the respective weights of the connections for each connected agent;
determining, by the agent, that a current model generated from current weights for the connections of the one or more connected agents satisfies the one or more goal criteria; and
publishing, by the agent, output of the current model to a search engine, thereby making the output of the current model available for consumption by other agents in the intelligence aggregation system.

16. The method of claim 15, further comprising:
evaluating each subset of a plurality of subsets of the data outputs generated by the connected agents, including:
generating an initial model using only data sources in the subset,
determining, for each data source in the subset, whether the data source is sufficiently predictive of a target variable of the goal criteria, and
adding, to a final set of data sources, only the data sources in the subset that are sufficiently predictive of the target variable of the goal criteria; and
training the model using only data sources in the final set of data sources.

17. The method of claim 16, wherein each initial model has fewer inputs, less training data, and requires less training time, than the final model.

18. The method of claim 15, further comprising:
receiving, from another agent, a request to establish a connection; and
providing the output of the current model to the other agent for consumption by the other agent in response to the request.

19. The method of claim 15, further comprising:
receiving, by a search engine from a first agent, a publication of output data generated by the first agent;
receiving, by the search engine from a second agent, a query for output data;
determining, by the search engine, that the output data generated by the first agent satisfies the query; and
providing, by the search engine, an identification of the first agent to the second agent.

20. One or more non-transitory computer storage media encoded with computer program instructions that when executed by one or more computers cause the one or more computers to perform operations implementing a plurality of agents in an intelligence aggregation system, each agent being configured to perform operations comprising:
receiving one or more goal criteria;
performing a search to identify one or more other agents in the system that generate data outputs that are candidate features for training a model satisfying the goal criteria;
establishing a respective connection with the one or more other agents, each connection having an initial weight;
receiving data outputs generated by each connected agent;
iteratively training a model using the received data outputs from each connected agent as features and adjusting the respective weights of the connections for each connected agent;
determining that a current model generated from current weights for the connections of the one or more connected agents satisfies the one or more goal criteria; and
publishing output of the current model to a search engine.
